(19) United States
(12) Patent Application Publication
(10) Pub. No.: US 2025/0364677 A1
(43) Pub. Date: Nov. 27, 2025

(54) CAP ASSEMBLY AND SECONDARY BATTERY INCLUDING THE SAME

(71) Applicant: SAMSUNG SDI CO., LTD., Yongin-Si (KR)

(72) Inventor: Taewoong JANG, Yongin-Si (KR)

(21) Appl. No.: 18/913,881

(22) Filed: Oct. 11, 2024

(30) Foreign Application Priority Data
May 27, 2024 (KR) 10-2024-0068760

(51) Int. Cl. H01M 50/367; H01M 50/109; H01M 50/153; H01M 50/559

(52) U.S. Cl. CPC H01M 50/367; H01M 50/109; H01M 50/153; H01M 50/559

(57) ABSTRACT

A secondary battery includes: an electrode assembly; a can having an inner space to accommodate the electrode assembly, and including a first side that is opened; a cover plate connected to the opened first side of the can, and having a through-hole; a terminal cap connected to the cover plate to cover the through-hole; and a connecting member to guide gas generated from the electrode assembly to be discharged from the inner space to the outside. At least a portion of the connecting member is located between the cover plate and the terminal cap.

### CROSS-REFERENCE TO RELATED APPLICATION

The present application claims priority to and the benefit of Korean Application No. 10-2024-0068760, filed on May 27, 2024, in the Korean Intellectual Property Office, the entire disclosure of which is incorporated by reference herein.

### BACKGROUND

### 1. Field

Aspects of embodiments of the present disclosure relate to a cap assembly, and a secondary battery including the cap assembly.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

In a secondary battery manufacturing process, gas may be generated inside a cell. In this case, because the gas inside the cell may impair the durability and safety of the cell, it may be desirable to remove the gas.

The above information disclosed in this Background section is for enhancement of understanding of the background of the present disclosure, and therefore, it may contain information that does not constitute related (or prior) art.

### SUMMARY

Embodiments of the present disclosure may be directed to a cap assembly, and a secondary battery including the cap assembly.

These and other aspects and features of the present disclosure will be described in or will be apparent from the following description of embodiments of the present disclosure.

According to one or more embodiments of the present disclosure, a secondary battery includes: an electrode assembly; a can having an inner space configured to accommodate the electrode assembly, and including a first side that is opened; a cover plate connected to the opened first side of the can, and having a through-hole; a terminal cap connected to the cover plate to cover the through-hole; and a connecting member configured to guide gas generated from the electrode assembly to be discharged from the inner space to the outside. At least a portion of the connecting member is located between the cover plate and the terminal cap.

In an embodiment, the connecting member may include an inlet at a first end configured to allow gas to flow from the inner space therethrough, and an outlet at a second end configured to discharge the gas therethrough.

In an embodiment, the secondary battery may further include a collecting member connected to the connecting member, and configured to collect the gas discharged through the connecting member.

In an embodiment, the collecting member may be separably connected to the second end of the connecting member.

In an embodiment, in a state in which the collecting member is separated from the connecting member, the second end of the connecting member may be heat-compressed and sealed to prevent gas from being discharged through the outlet.

In an embodiment, the connecting member may include: a first polymer layer having a passage through which the gas may be configured to be moved; a metal layer on the first polymer layer; and a second polymer layer on the metal layer.

In an embodiment, each of the first polymer layer and the second polymer layer may include polypropylene (PP), and the metal layer may include aluminum (Al).

In an embodiment, the cover plate and the terminal cap may be sealed to each other through an adhesive member in a state in which the connecting member may be located between the cover plate and the terminal cap, and the adhesive member may be located between the connecting member and the cover plate, and/or between the connecting member and the terminal cap.

In an embodiment, a melting point of the adhesive member may be lower than a melting point of the first polymer layer.

According to one or more embodiments of the present disclosure, a cap assembly includes: a cover plate having a through-hole; a terminal cap connected to the cover plate; and a collection device including: a connecting member having a first end facing toward the through-hole; and a collecting member at a second end of the connecting member.

In an embodiment, an inlet may be at the first end of the connecting member, and an outlet may be at the second end of the connecting member.

In an embodiment, the collecting member may be separably connected to the second end of the connecting member.

In an embodiment, in a state in which the collecting member is separated from the connecting member, the second end of the connecting member may be heat-compressed to close the outlet.

In an embodiment, the connecting member may include: a first polymer layer having a passage through which gas may be configured to be moved; a metal layer on the first polymer layer; and a second polymer layer on the metal layer.

In an embodiment, each of the first polymer layer and the second polymer layer may include polypropylene (PP), and the metal layer may include aluminum (Al).

In an embodiment, the cover plate and the terminal cap may be attached to each other through an adhesive member in a state in which the connecting member may be located between the cover plate and the terminal cap, and the adhesive member may be located between the connecting member and the cover plate, and/or between the connecting member and the terminal cap.

In an embodiment, a melting point of the adhesive member may be lower than a melting point of the first polymer layer.

According to one or more embodiments of the present disclosure, a secondary battery includes: an electrode assembly; a can having an inner space configured to accommodate the electrode assembly, and including a first side that is opened; and a cap assembly connected to the opened first side. The cap assembly includes: a cover plate having a through-hole; a terminal cap connected to the cover plate; and a collection device including: a connecting member between the cover plate and the terminal cap, and having a first end facing toward the through-hole; and a collecting member at a second end of the connecting member. The cover plate and the terminal cap are sealed to each other through an adhesive member in a state in which the connecting member is located between the cover plate and the terminal cap.

In an embodiment, the collecting member may be separably connected to the second end of the connecting member, and in a state in which the collecting member is separated from the connecting member, the second end of the connecting member may be heat-compressed and sealed.

In an embodiment, the connecting member may include: a first polymer layer having a passage through which gas may be configured to be moved; a metal layer on the first polymer layer; and a second polymer layer on the metal layer. A melting point of the adhesive member may be lower than a melting point of the first polymer layer.

According to some embodiments of the present disclosure, the durability and safety of secondary batteries may be improved.

According to some embodiments of the present disclosure, an increase in a resistance of secondary batteries may be prevented or substantially prevented.

According to some embodiments of the present disclosure, gas inside secondary batteries may be discharged.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 illustrates a perspective view of a secondary battery according to some embodiments of the present disclosure.

FIG. 2 illustrates an exploded view of the secondary battery of FIG. 1.

FIG. 3 illustrates a cross-sectional view of the secondary battery taken along the line I-I′ of FIG. 2.

FIG. 4 illustrates a cross-sectional view of a cap assembly of the secondary battery according to some embodiments of the present disclosure.

FIG. 5 illustrates a cross-sectional view schematically illustrating a structure of the cap assembly.

FIG. 6 illustrates an enlarged cross-sectional view of the region A of FIG. 4.

FIG. 7 illustrates an enlarged cross-sectional view of the region B of FIG. 4.

FIG. 8 illustrates a state in which a collecting member is separated from a terminal plate of FIG. 4.

FIG. 9 illustrates an enlarged cross-sectional view of the region C of FIG. 8.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

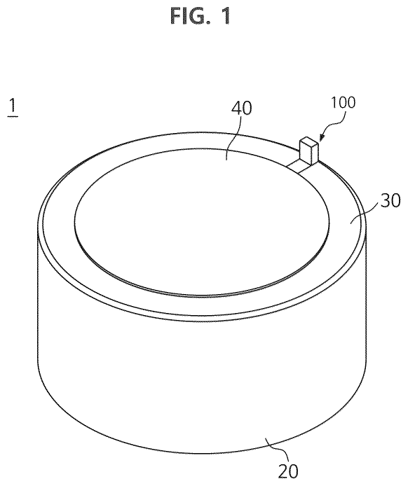

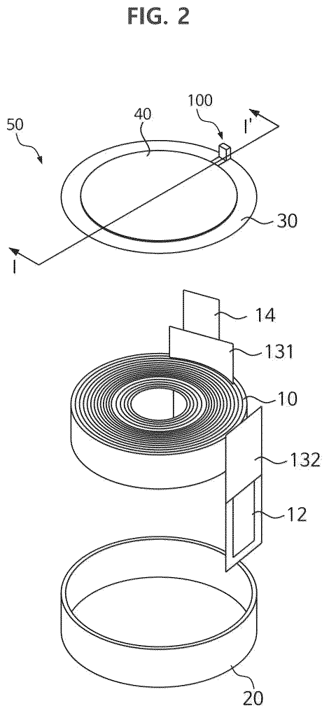

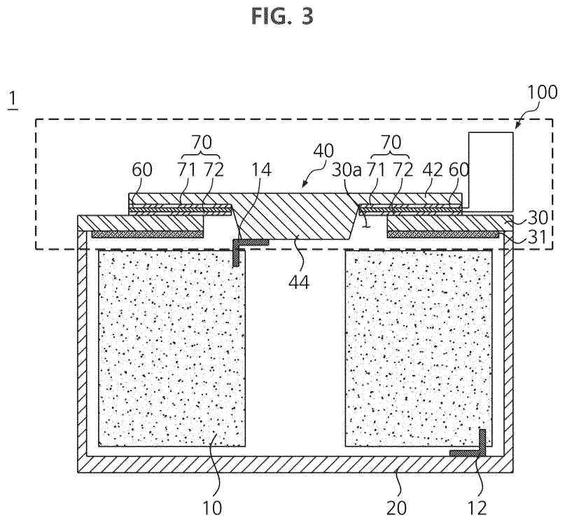

FIG. 1 illustrates a perspective view of a secondary battery according to some embodiments of the present disclosure. FIG. 2 illustrates an exploded view illustrating the secondary battery of FIG. 1. FIG. 3 illustrates a cross-sectional view of the secondary battery taken along the line I-I′ of FIG. 2.

A secondary battery according to one or more embodiments is a micro-sized secondary battery and may be a coin cell or a button cell but is not limited thereto and may be a cylindrical or pin-type battery.

The coin cell or button cell is a battery in the form of a thin coin or button and may refer to a battery having a ratio of height to diameter (height/diameter) of 1 or less but is not limited thereto. Because the coin cell or button cell is generally cylindrical, the cross section in the horizontal direction is generally circular. However, the cross section in the horizontal direction is not limited thereto and may have an elliptical or polygonal shape. The diameter may refer to a maximum distance in the horizontal direction of the battery, and the height may refer to a maximum distance in the vertical direction of the battery (e.g., distance from the flat bottom surface to the flat top surface of the battery).

Referring to FIGS. 1 to 3, a secondary battery 1 according to some embodiments of the present disclosure may include an electrode assembly 10, a can 20, and a cap assembly 50.

The electrode assembly 10 may include a first electrode and a second electrode respectively provided on opposite surfaces of a separator including an insulating material. The electrode assembly 10 may be formed in the form of a jelly roll as a whole by sequentially stacking and then winding the first electrode, the separator, and the second electrode. Accordingly, the electrode assembly 10 may be provided in a cylindrical shape in which the first electrode and the second electrode are sequentially stacked with the separator therebetween, and the top surface and the bottom surface of the cylindrical shape may be flat or substantially flat.

In some embodiments, an insulating washer 31 may be disposed on the top surface of the electrode assembly 10 to electrically separate the first electrode and the second electrode located therebelow from a first electrode tab 14 and a cap assembly 50 located thereabove. For example, the insulating washer 31 may include a resin composition. In some embodiments, an insulating sheet may also be disposed on the bottom surface of the electrode assembly 10, if necessary or desired.

Each of the first electrode and the second electrode may be provided in the form of a strap coated with an active material, and may be combined with (e.g., connected to or coupled to) the corresponding surface of the opposite surfaces of the separator.

A first cover tape 131 may be disposed to strengthen the joining between the first electrode tab 14 and the electrode assembly 10. The first cover tape 131 may be provided to have a larger width than that of the first electrode tab 14, and may be bonded to the first electrode tab 14 at a central portion thereof. The first cover tape 131 may be bonded to the electrode assembly 10 at opposite circumferential portions of the first electrode tab 14. Accordingly, the first electrode tab 14 may be stably bonded to the electrode assembly 10.

A second cover tape 132 may be disposed to strengthen the joining between a second electrode tab 12 and the electrode assembly 10. The second cover tape 132 may be provided to have a larger width than that of the second electrode tab 12, and may be bonded to the second electrode tab 12 at a central portion thereof. The second cover tape 132 may be bonded to the electrode assembly 10 at opposite circumferential portions of the second electrode tab 12. Accordingly, the second electrode tab 12 may be stably bonded to the electrode assembly 10.

The can 20 may have an inner space in which the electrode assembly 10 is accommodated. One surface of the can 20 may be opened to accommodate the electrode assembly 10. The can 20 may have a cylindrical shape. For example, the can 20 may be formed in a cylindrical shape, and may accommodate the jelly roll-shaped electrode assembly 10.

The cover plate 30 may be joined to the can 20 so as to cover the one opened surface of the can 20. For example, an edge of the cover plate 30 may be joined to cover an opening of the can 20 (e.g., an edge of the opened surface of the can 20). In some embodiments, each of the can 20 and the cover plate 30 may include a conductive metal material, and the edge of the cover plate 30 and the edge of the can 20 at the opening of the can 20 may be joined to each other by a metal joint (e.g., a welding, a brazing, a soldering, and/or the like).

A through-hole 30a may be formed at the central portion of the cover plate 30. For example, the through-hole 30a may have a circular shape having the same center as that of the cover plate 30, but having a diameter less than that of the cover plate 30.

The can 20 and the cover plate 30 may be connected to (e.g., may have) the same electrode as each other. For example, the can 20 and/or the cover plate 30 may be in contact with the second electrode tab 12 that is connected to the second electrode (e.g., the negative electrode), and thus, the can 20 and the cover plate 30 may be electrically connected to the second electrode.

A terminal cap 40 may be disposed on the cover plate 30 in a state of being insulated from the cover plate 30.

The terminal cap 40 may include a terminal plate 42 and an insertion portion 44. For example, the terminal plate 42 may be circular, and the insertion portion 44 may protrude from the central portion of the terminal plate 42 to be inserted into the through-hole 30a of the cover plate 30.

The terminal cap 40 may be connected to (e.g., may have) an electrode that is different from that of the can 20 and the cover plate 30. For example, the insertion portion 44 of the terminal cap 40, which is inserted into the through-hole 30a, may be in contact with the first electrode tab 14 that is connected to the first electrode (e.g., the positive electrode), and thus, the terminal cap 40 may be electrically connected to the first electrode. In some embodiments, the terminal cap 40 may function as a terminal of the first electrode.

An insulating member 60 may be disposed between the cover plate 30 and the terminal cap 40. For example, the insulating member 60 may have a ring shape surrounding (e.g., around) the periphery of the through-hole 30a of the cover plate 30, and may be disposed between the cover plate 30 and the terminal cap 40. The insulating member 60 may insulate between the cover plate 30 and the terminal cap 40 that are connected to (e.g., having) different electrodes from each other.

The insulating member 60 may include any suitable insulating material, and may be applied to (e.g., may be attached, disposed, coated, or the like on) the secondary battery 1 in any suitable form, such as an insulating tape, an insulating sheet, or an insulating paste.

An adhesive member 70 that seals between the cover plate 30 and the terminal cap 40 may be disposed between the cover plate 30 and the terminal cap 40. The adhesive member 70 may include a first adhesive member 71 disposed between the insulating member 60 and the terminal cap 40, and a second adhesive member disposed between the insulating member 60 and the cover plate 30. The adhesive member 70 may insulate between the cover plate 30 and the terminal cap 40.

However, the present disclosure is not limited thereto, and the adhesive member 70 and the insulating member 60 may be integrally formed together.

FIGS. 1 to 3 illustrate an example of the secondary battery 1 according to some embodiments of the present disclosure, and the secondary battery 1 may further include other elements different from those described with reference to FIGS. 1 to 3.

For example, one or more insulating members (e.g., an insulating member that insulates a portion of the electrode assembly 10 and the can 20, and/or the like) may be further disposed in the secondary battery 1.

In a process of manufacturing the secondary battery 1, gas may be generated from the electrode assembly 10. In more detail, gas may be generated from the electrode assembly 10 during a formation process of the secondary battery 1. The generated gas may be trapped in an inner space of the can 20. The gas trapped in the inner space of the can 20 may leave in a state in which the secondary battery 1 is in a high temperature or a high voltage state. In this case, additional gas that may be generated may rapidly increase a resistance of the secondary battery 1. Therefore, it may be desirable to remove the gas generated from the electrode assembly 10.

The secondary battery 1 according to some embodiments of the present disclosure may further include a collection device 100 for removing the gas generated from the electrode assembly 10.

At least a portion of the collection device 100 may be disposed between the cover plate 30 and the terminal cap 40. In some embodiments, at least a portion of the collection device 100 may be disposed between the cover plate 30 and the terminal plate 42 of the terminal cap 40. The gas generated in the inner space of the can 20 may be collected into the collection device 100 through the through-hole 30a.

Hereinafter, the cap assembly 50 including the collection device 100 may be described in more detail with reference to some additional figures.

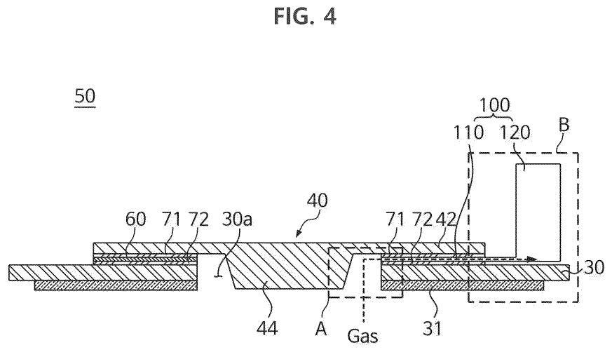

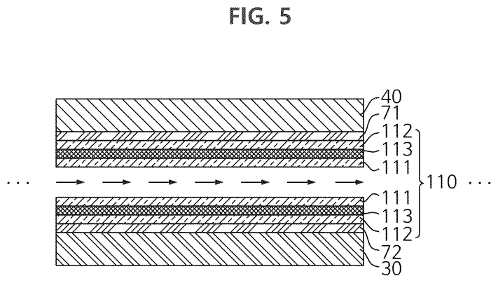

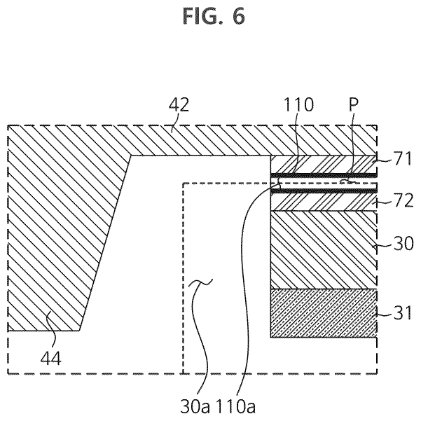

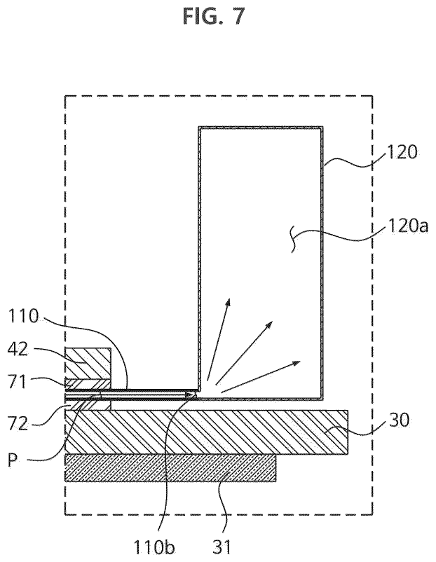

FIG. 4 illustrates a cross-sectional view of the cap assembly of the secondary battery according to some embodiments of the present disclosure. FIG. 5 illustrates a cross-sectional view schematically illustrating a structure of the cap assembly. FIG. 6 illustrates an enlarged cross-sectional view of the region A of FIG. 4. FIG. 7 illustrates an enlarged cross-sectional view of the region B of FIG. 4.

Referring to FIGS. 4 to 7, the cap assembly 50 may include the collection device 100 disposed to discharge gas from the inner space of the can 20.

The collection device 100 may include a connecting member 110 that guides the gas generated from the electrode assembly 10 to be discharged to the outside. The connecting member 110 may connect the inner space of the can 20 to the outside of the can 20.

The connecting member 110 may be disposed so that one end of the connecting member 110 faces the inner space of the can 20. Another end (e.g., an opposite end) of the connecting member 110 may be disposed to face outward.

The connecting member 110 may include an inlet 110a formed to allow gas to flow from the inner space of the can 20. The inlet 110a may be formed at the one end of the connecting member 110. The gas generated from the electrode assembly 10 may flow into the inlet 110a.

The connecting member 110 may include an outlet 110b through which the gas flowing into the inlet 110a is discharged. The outlet 110b may be formed at the other end of the connecting member 110.

The connecting member 110 may form a passage P through which the gas flowing into the inlet 110a is discharged to the outlet 110b. The passage P may connect the one end of the connecting member 110 to the other end of the connecting member 110. The passage P may be formed along the longitudinal direction of the connecting member 110. The connecting member 110 may be a tube through which gas is movable.

At least a portion of the connecting member 110 may be disposed between the cover plate 30 and the terminal cap 40. The one end of the connecting member 110 may be disposed to face the through-hole 30a of the cover plate 30. The other end of the connecting member 110 may be disposed to face the outside of the can 20.

The collection device 100 may include a collecting member 120 connected to the connecting member 110. In some embodiments, the collecting member 120 may be connected to the other end of the connecting member 110. The gas generated from the electrode assembly 10 may be collected by the collecting member 120 through the passage P formed in the connecting member 110.

Referring to FIG. 5, the connecting member 110 may include a first polymer layer 111 for forming a passage P through which gas is moved, a metal layer 113 disposed on the first polymer layer 111, and a second polymer layer 112 disposed on the metal layer 113. In other words, the first polymer layer 111 may be disposed in the innermost portion. The first polymer layer 111 may be fused by thermal compression. In other words, the passage P may be closed to prevent or substantially prevent gas from moving. In some embodiments, an adhesive layer may be disposed between the first polymer layer 111 and the metal layer 113, or between the second polymer layer 112 and the metal layer 113.

Each of the first polymer layer 111 and the second polymer layer 112 may be formed of a polymer resin. For example, each of the first polymer layer 111 and the second polymer layer 112 may be formed of polypropylene (PP). However, the present disclosure is not limited thereto, and each of the first polymer layer 111 and the second polymer layer 112 may be formed of various suitable materials, such as polyimide (PI), polyamide (PA), or polyethylene (PE). In some embodiments, the first polymer layer 111 and the second polymer layer 112 may be formed of different materials from each other. For example, the first polymer layer 111 may be formed of polypropylene (PP), and the second polymer layer 112 may be formed of nylon.

The metal layer 113 may be formed of aluminum (Al). In some embodiments, the metal layer 113 may be formed of an aluminum (Al) foil. The metal layer 113 may be thin and flexible. However, the present disclosure is not limited thereto, and the metal layer 113 may be formed of various suitable metals.

The connecting member 110 may be disposed between the terminal cap 40 and the cover plate 30. The cover plate 30 and the terminal cap 40 may be sealed together by the adhesive members 71 and 72 in a state in which the connecting member 110 is disposed between the cover plate 30 and the terminal cap 40. In other words, the cover plate 30 and the terminal cap 40 may be bonded to each other with the connecting member 110 therebetween.

The adhesive member 70 may include the first adhesive member 71 disposed between the second polymer layer 112 and the terminal cap 40, and the second adhesive member 72 disposed between the second polymer layer 112 and the cover plate 30. However, the present disclosure is not limited thereto, and the adhesive member 70 may be disposed only between the second polymer layer 112 and the terminal cap 40, or may be disposed only between the second polymer layer 112 and the cover plate 30.

The adhesive member 70 may be fused through heat compression so as to seal between the terminal cap 40 and the cover plate 30. In this case, the melting point of the first polymer layer 111 may be higher than the melting point of the adhesive member 70, so that the first polymer layer 111 forming the passage P of the collection device 100 may not be fused to close the passage P. In other words, the melting point of the adhesive member 70 may be lower than the melting point of the first polymer layer 111. For example, the melting point of the first polymer layer 111 may be 300° C., and the melting point of the adhesive member 70 may be 200° C. In this case, if the terminal cap 40 and the cover plate 30 are heated and pressed to a temperature of 250° C., the adhesive member 70 may be melted and bonded. In some embodiments, because the first polymer layer 111 is not melted, the passage P may not be closed. As such, the gas generated in the inner space of the can 20 (e.g., see FIG. 3) may be discharged through the inlet 110a of the connecting member 110.

The process in which gas is moved from the inner space of the can 20 toward the collecting member 120 will be described in more detail below with reference to FIGS. 6 and 7.

The electrode assembly 10 (e.g., see FIG. 3) may be accommodated in the inner space of the can 20. A formation process may be performed to impart electrical properties to the electrode assembly 10. A process of charging and discharging the electrode assembly 10 may be repeated. After charging and discharging the electrode assembly 10, a stabilization process may be performed so that an electrolyte is evenly distributed in the electrode assembly 10. During the charging and discharging process and the stabilization process, gas may be generated in the electrode assembly 10. In other words, the gas may be generated in the inner space of the can 20.

The pressure in the inner space of the can 20 may gradually increase due to the gas generated from the electrode assembly 10 through the formation process. The can 20 should discharge gas so as to prevent or substantially prevent deformation from occurring due to the increased internal pressure. Due to the increased internal pressure, the gas inside the can 20 may be moved, so as to be discharged to the outside.

The generated gas may be moved through the through-hole 30a formed in the cover plate 30. Because the inlet 110a of the connecting member 110 is disposed toward the through-hole 30a, the gas may be moved into the passage P of the connecting member 110 through the inlet 110a. The gas may be discharged to the outlet 110b along the passage P.

The collecting member 120 may be connected to the other end of the connecting member 110. In other words, the gas discharged through the outlet 110b may be collected in the collecting member 120. A collecting space 120a may be formed inside the collecting member 120. The volume of the collecting space 120a may increase due to the gas discharged through the outlet 110b. Because the connecting member 110 may include a thin metal layer 113, the connecting member 110 may expand as the gas is trapped. As such, during the formation process, the gas generated in the inner space of the can 20 may be discharged to the outside. In some embodiments, the gas may be collected in the collecting member 120, so that the gas is not discharged to the atmosphere.

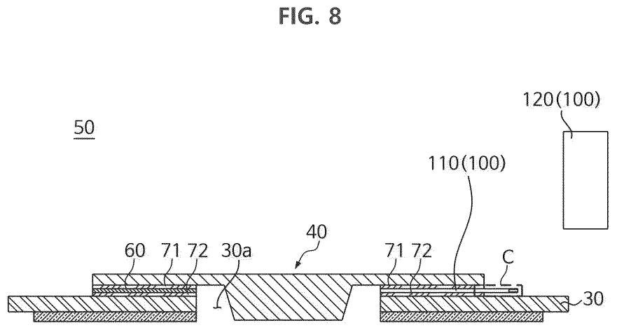

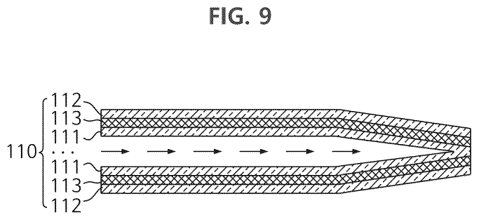

FIG. 8 illustrates a state in which a collecting member is separated from a terminal plate of FIG. 4. FIG. 9 illustrates an enlarged cross-sectional view of the region C of FIG. 8.

Referring to FIGS. 8 and 9, the collecting member 120 may be removed from the connecting member 110. In other words, the gas collected in the collecting member 120 may be removed.

The collecting member 120 may be connected to the other end of the connecting member 110. The collecting member 120 may collect gas until the gas generated inside the can 20 is sufficiently discharged. For example, the collecting member 120 may collect the gas until the formation process ends, or in other words, until the process of generating gas from the electrode assembly 10 ends. The gas collected in the collecting member 120 may separate the collecting member 120 from the connecting member 110. In other words, the gas collected inside the collecting member 120 may be removed.

The collecting member 120 may be separated from the other end of the connecting member 110. For example, the collecting member 120 may be separated by cutting or tearing the other end of the connecting member 110.

After the collecting member 120 is separated, the other end of the connecting member 110 may be in an opened state. Because the outlet 110b of the connecting member 110 is in the opened state, the electrolyte inside the can 20 may leak out. In some embodiments, gas may additionally leak out from the inner space of the can 20. As such, it may be desirable to seal the other end of the connecting member 110.

The other end of the connecting member 110 may be heat-compressed to seal the outlet 110b. However, the method of sealing the other end of the connecting member 110 is not limited thereto. For example, the other end of the connecting member 110 may be sealed by being filled with a separate material.

In some embodiments, the other end of the connecting member 110 may be sealed by heat compression, so as to prevent or substantially prevent gas from being discharged through the outlet 110b in a state in which the collecting member 120 is separated. In some embodiments, the first polymer layer 111 forming the passage P inside the connecting member 110 may be fused by thermal compression. In a case where the first polymer layer 111 is fused, the outlet 110b may be closed, thereby preventing or substantially preventing gas from being discharged. According to other embodiments, the separation of the collecting member 120 and the sealing of the outlet 110b may be performed concurrently (e.g., simultaneously or substantially simultaneously) with each other.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

What is claimed is:

1. A secondary battery comprising:
an electrode assembly;
a can having an inner space configured to accommodate the electrode assembly, and comprising a first side that is opened;
a cover plate connected to the opened first side of the can, and having a through-hole;
a terminal cap connected to the cover plate to cover the through-hole; and
a connecting member configured to guide gas generated from the electrode assembly to be discharged from the inner space to the outside,
wherein at least a portion of the connecting member is located between the cover plate and the terminal cap.

2. The secondary battery as claimed in claim 1, wherein the connecting member comprises an inlet at a first end configured to allow gas to flow from the inner space therethrough, and an outlet at a second end configured to discharge the gas therethrough.

3. The secondary battery as claimed in claim 2, further comprising a collecting member connected to the connecting member, and configured to collect the gas discharged through the connecting member.

4. The secondary battery as claimed in claim 3, wherein the collecting member is separably connected to the second end of the connecting member.

5. The secondary battery as claimed in claim 4, wherein, in a state in which the collecting member is separated from the connecting member, the second end of the connecting member is heat-compressed and sealed to prevent gas from being discharged through the outlet.

6. The secondary battery as claimed in claim 1, wherein the connecting member comprises:
a first polymer layer having a passage through which the gas is configured to be moved;
a metal layer on the first polymer layer; and
a second polymer layer on the metal layer.

7. The secondary battery as claimed in claim 6, wherein each of the first polymer layer and the second polymer layer comprises polypropylene (PP), and the metal layer comprises aluminum (Al).

8. The secondary battery as claimed in claim 6, wherein the cover plate and the terminal cap are sealed to each other through an adhesive member in a state in which the connecting member is located between the cover plate and the terminal cap, and
wherein the adhesive member is located between the connecting member and the cover plate, and/or between the connecting member and the terminal cap.

9. The secondary battery as claimed in claim 8, wherein a melting point of the adhesive member is lower than a melting point of the first polymer layer.

10. A cap assembly comprising:
a cover plate having a through-hole;
a terminal cap connected to the cover plate; and
a collection device comprising:
a connecting member having a first end facing toward the through-hole; and
a collecting member at a second end of the connecting member.

11. The cap assembly as claimed in claim 10, wherein an inlet is at the first end of the connecting member, and an outlet is at the second end of the connecting member.

12. The cap assembly as claimed in claim 11, wherein the collecting member is separably connected to the second end of the connecting member.

13. The cap assembly as claimed in claim 12, wherein, in a state in which the collecting member is separated from the connecting member, the second end of the connecting member is heat-compressed to close the outlet.

14. The cap assembly as claimed in claim 10, wherein the connecting member comprises:
a first polymer layer having a passage through which gas is configured to be moved;
a metal layer on the first polymer layer; and
a second polymer layer on the metal layer.

15. The cap assembly as claimed in claim 14, wherein each of the first polymer layer and the second polymer layer comprises polypropylene (PP), and the metal layer comprises aluminum (Al).

16. The cap assembly as claimed in claim 14, wherein the cover plate and the terminal cap are attached to each other through an adhesive member in a state in which the connecting member is located between the cover plate and the terminal cap, and
wherein the adhesive member is located between the connecting member and the cover plate, and/or between the connecting member and the terminal cap.

17. The cap assembly as claimed in claim 16, wherein a melting point of the adhesive member is lower than a melting point of the first polymer layer.

18. A secondary battery comprising:
an electrode assembly;
a can having an inner space configured to accommodate the electrode assembly, and comprising a first side that is opened; and
a cap assembly connected to the opened first side,
wherein the cap assembly comprises:
a cover plate having a through-hole;
a terminal cap connected to the cover plate; and
a collection device comprising:
a connecting member between the cover plate and the terminal cap, and having a first end facing toward the through-hole; and
a collecting member at a second end of the connecting member, and
wherein the cover plate and the terminal cap are sealed to each other through an adhesive member in a state in which the connecting member is located between the cover plate and the terminal cap.

19. The secondary battery as claimed in claim 18, wherein the collecting member is separably connected to the second end of the connecting member, and
wherein, in a state in which the collecting member is separated from the connecting member, the second end of the connecting member is heat-compressed and sealed.

20. The secondary battery as claimed in claim 18, wherein the connecting member comprises:
a first polymer layer having a passage through which gas is configured to be moved;
a metal layer on the first polymer layer; and
a second polymer layer on the metal layer, and
wherein a melting point of the adhesive member is lower than a melting point of the first polymer layer.
